(19) United States
(12) Patent Application Publication
(10) Pub. No.: US 2020/0209849 A1
(43) Pub. Date: Jul. 2, 2020

(54) DEVICE FOR SIGNALLING DRIVING PHASE(S) OF AN AUTONOMOUS VEHICLE

(71) Applicant: PSA AUTOMOBILES SA, Poissy (FR)

(72) Inventors: Jean Luc POGNON, PUTEAUX (FR); Saran DIAKITE KABA, BIEVRES (FR); Franck BREVET, LE CHESNAY (FR); Sandrine DELENNE, PALAISEAU (FR); Virgile CHARTON, PARIS (FR)

(21) Appl. No.: 16/494,688

(22) PCT Filed: Mar. 12, 2018
(86) PCT No.: PCT/FR2018/050577

§ 371 Date: Jan. 27, 2020

(30) Foreign Application Priority Data
Mar. 23, 2017 (FR) 1752402

(51) Int. Cl. G05D 1/00; B60W 60/00; B60W 50/08

(52) U.S. Cl. CPC G05D 1/0061; B60W 60/005; B60W 2050/0068; B60W 2756/10; B60W 2710/30; B60W 50/082

(57) ABSTRACT

A signalling device (DS) equips a vehicle (VA) that can be driven by a driver during a manual driving phase and that comprises an assistance device (DA) capable of driving it in a completely autonomous manner during an autonomous driving phase. This device (DS) comprises signalling means (MS1-MS2) capable of being installed on at least two lateral parts (PL1-PL2) of the vehicle (VA) and of generating a first light of a first chosen colour, visible from outside the vehicle (VA), upon reception of a first command, and control means (MC) capable of generating the first command for said signalling means (MS1-MS2) when the vehicle (VA) is in an autonomous driving phase. Moreover, the signalling means (MS1-MS2) are capable of generating a second light of a second chosen colour, visible from outside the vehicle (VA), upon reception of a second command, and the control means (MC) are capable of generating the first command when the driver is absent from the vehicle (VA), and of generating the second command for the signalling means (MS1-MS2) when the vehicle (VA) is in an autonomous driving phase and the driver is present in the vehicle (VA), or of generating the first command when said driver is present in said vehicle (VA), and of generating a second command for the signalling means (MS1-MS2) when the vehicle (VA) is in an autonomous driving phase and the driver is absent from said vehicle (VA).

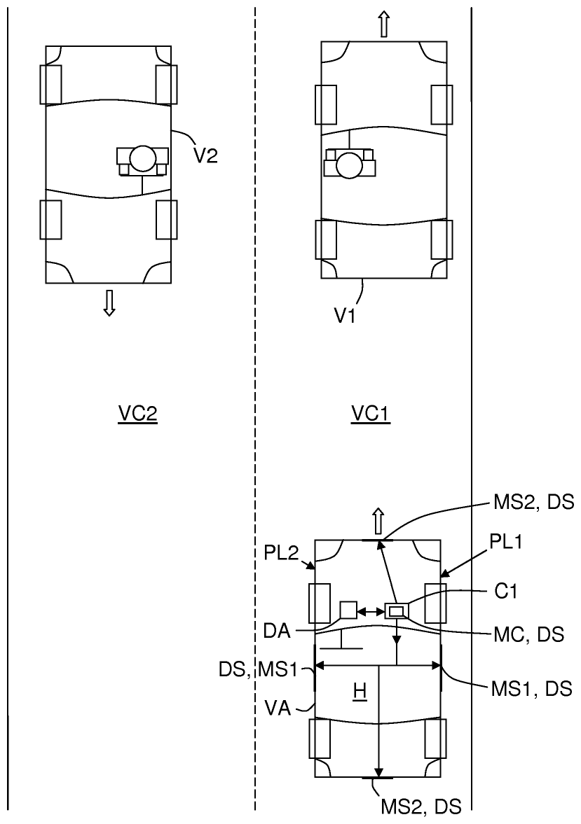

### CROSS-REFERENCE TO RELATED APPLICATIONS

This application is the US National Stage under 35 USC § 371 of International Application No. PCT/FR2018/050577, filed 12 Mar. 2018 which claims priority to French Application No. 1752402 filed 23 Mar. 2017, both of which are incorporated herein by reference.

### BACKGROUND

The invention relates to self-driving vehicles, possibly of the automotive type, and more specifically to the signaling of such vehicles.

As known to the person skilled in the art, some vehicles, generally of the automotive type, include an assistance device responsible for driving such vehicles without the driver interacting with the steering wheel and/or the pedals, hence their designation under the term “autonomous driving vehicle” (or in simpler terms “autonomous vehicle”).

Some of these autonomous driving vehicles may be either driven by a driver during a manual driving phase, or completely autonomously during an autonomous driving phase, and there is a transition phase between an autonomous driving phase and a manual driving phase.

During an autonomous driving phase, it is the assistance device that fully manages the driving, whether or not there is a driver in the vehicle. During a transition phase between an autonomous driving phase and a manual driving phase, which may last several seconds, the driver regains full control of the driving after the vehicle has been subjected to stresses (for example, visual or audible), and therefore the assistance device stops controlling the vehicle. During a transition phase between a manual driving phase and an autonomous driving phase, which can also last several seconds, the assistance device takes control of the driving and therefore the driver stops controlling the vehicle, depending on the level of automation.

When an autonomous vehicle runs without a driver or with a driver doing anything other than driving it, people next to the autonomous vehicle who may observe it (e.g., users of traffic lanes or pedestrians) may be surprised or even panicked causing abnormal and potentially dangerous reactions in some of these people. Such reactions will continue as long as it is impossible for a third party to know whether the vehicle he is encountering includes an assistance device for activated autonomous driving.

### SUMMARY

The purpose of the invention is, in particular, to improve this situation.

For this purpose a signaling device is disclosed for equipping a vehicle capable of being driven by a driver during a manual driving phase and comprising an assistance device capable of driving it completely autonomously during an autonomous driving phase.

This signaling device is characterized by the fact that it comprises:
signaling means adapted to be installed on at least two side portions of the vehicle and to generate a first light of a first selected color, visible from the outside of the vehicle, in case of receipt of a first command, and
control means adapted to generate the first command for the signaling means when the vehicle is in an autonomous driving phase.

By means of this signaling by a first light on at least the side portions of the vehicle, a third party can instantly understand that this vehicle is in an autonomous driving phase (controlled by its assistance device), which allows immediate reassurance of the third party.

The signaling device according to the invention may comprise other features that may be included separately or in combination, and in particular:
in a first embodiment, the control means may be able to generate the first command when the driver is absent from the vehicle, and to generate a second command for the signaling means when the vehicle is in an autonomous driving phase and [[that]] the driver is present in the vehicle. In this case, its signaling means may be able to generate a second light of a second selected color, visible from outside the vehicle, in case of receipt of this second command;
   the signaling means may be able to generate the second light intermittently in case of receipt of a third command. In this case, the control means may be able to generate the third command for the signaling means when the vehicle is in a transition phase between an autonomous driving phase and a manual driving phase;
in a second embodiment, the control means may be able to generate the first command when the driver is present in the vehicle, and to generate a second command for the signaling means when the vehicle is in an autonomous driving phase and the driver is absent from the vehicle. In this case, the signaling means may be able to generate a second light of a second selected color, visible from outside the vehicle, in case of receipt of the second command;
   the signaling means may be adapted to generate the first light intermittently in case of receipt of a third command. In this case, the control means may be able to generate the third command for the signaling means when the vehicle is in a transition phase between an autonomous driving phase and a manual driving phase;
in an alternative embodiment, the signaling means may be adapted to generate a third light of a third selected color, visible from outside the vehicle, and optionally intermittently, in case of receipt of a third command. In this case, the control means may be able to generate the third command for the signaling means when the vehicle is in a transition phase between an autonomous driving phase and a manual driving phase.

A vehicle, possibly of the automotive type, is also proposed and which is adapted to be driven by a driver during a manual driving phase, the vehicle comprising an assistance device able to drive the vehicle completely autonomously during an autonomous driving phase. This vehicle comprises a signaling device of the type disclosed above, which is at least partially installed on at least two side portions.

For example, at least a portion of the signaling device's signaling means may be installed on elements of the vehicle which are selected from side doors, optical units, a roof, side windows, vehicle body bottom structure, front fenders. rear fenders, parts defining vehicle brand logos, rear window, windshield, front bumper, rear bumper, tailgate, rear trunk door, and front hood.

### DESCRIPTION OF THE FIGURE

Other features and advantages of the invention will become clear by examining the detailed description below, and the accompanying drawing, in which the single figure schematically and functionally illustrates two road lanes in which vehicles travel, one of which comprises an assistance device for autonomous driving and an exemplary embodiment of a signaling device according to the invention.

### DETAILED DESCRIPTION

A signaling device DS is provided which is intended to equip an autonomous driving vehicle VA so as to signal to an outside third party the driving phases in which the vehicle is operating.

The term “autonomous driving vehicle” is defined here to mean a vehicle including an assistance device DA responsible for driving the vehicle without a passenger interacting with the steering wheel, and possibly capable of being activated or deactivated (at least partially) in order to allow a driver to drive the vehicle during a manual driving phase. Therefore, such a vehicle may either be driven by a driver during a manual driving phase, completely autonomously during an autonomous driving phase (under the control of its assistance device DA), and autonomously then manually during a transition phase occurring between an autonomous driving phase and a manual driving phase (transfer from the assistance device DA to the driver), or conversely manually and then autonomously during a transition phase occurring between a manual driving phase and an autonomous driving phase (transfer from the driver to the assistance device DA).

This assistance device DA provides control of the vehicle based, in particular, on information related to the external environment of the vehicle and provided at least by means for analyzing the external environment installed in the vehicle. With this aim in mind, the assistance device DA continuously determines the optimum trajectory of the vehicle in the context of automated driving, and, during each autonomous driving phase, the assistance device verifies the steering wheel angle and the speed of the vehicle so that the vehicle best follows the determined optimum trajectory.

By way of a non-limiting example, in the following description the autonomous driving vehicle VA is considered to be of the automotive type. This may be a car, for example. However, the invention is not limited to this type of vehicle. In fact, it concerns any type of autonomous driving vehicle, and therefore not only land vehicles, but also maritime (or river) vehicles, such as river taxis, and aircraft.

A road including two traffic lanes VC1 and VC2 in which three vehicles V1, V2 and VA are traveling is schematically and functionally represented in the sole figure. For example, this road is a two-way street in a city.

In this example, an autonomous driving vehicle VA travels in a first direction of traffic on the first traffic lane VC1, behind a non-autonomous vehicle V1, and another non-autonomous vehicle V2 travels on the second lane VC2 according to a second direction of traffic opposite to the first direction of traffic. It should be noted that in this case the autonomous vehicle VA does not include a driver, possibly temporarily.

The autonomous vehicle VA comprises an assistance device DA, responsible for driving without a passenger operating the steering wheel, and a signaling device DS according to the invention.

As illustrated in the single figure, a signaling device DS comprises at least signaling means MSj and control means MC.

The signaling means MSj can be (or is arranged to be) installed on at least side portions PLk (k=1 or 2) of the vehicle VA, and to generate a first light of a first selected color, visible from outside the vehicle VA, in case of receipt of a first command.

“Side portions” are understood here to mean portions that are substantially located on both longitudinal sides of the vehicle VA, in which the side doors are installed, in particular, enabling the passengers to enter the passenger compartment H.

Furthermore, “visible from outside the vehicle” is understood to mean that the light generated is visible by a third party outside the vehicle VA, and in particular opposite to any of the two side portions PLk of the latter (VA). Therefore, the light can be emitted on an outer face of an element of the vehicle VA or on an inner face of a transparent element of the vehicle VA.

It will be noted that the signaling means MSj comprises at least one light source, possibly associated with at least one optical element, for example a light guide, an optical fiber, a reflector, or a lens. Each light source is powered by the vehicle and may, for example and without limitation, include at least one conventional light-emitting diode (LED) or an organic light-emitting diode (OLED), or at least one laser diode.

By way of non-limiting examples, at least a part of the signaling means MSj may be installed on elements of the vehicle VA which are selected from the side doors, optical units, roof (or body ceiling), side windows, vehicle body bottom structure, front fenders, rear fenders, parts defining the logos of the brand of the vehicle VA, rear window, windshield, front bumper, rear bumper, the rear tailgate or the rear trunk door, and the front hood.

It will be noted that in the example illustrated in a non-limiting manner in the single figure, the signaling means MS1 (j=1) comprises light sources secured to the front side doors and the rear side doors (in continuity to form two rectilinear light strips of great length). However, they could be two short rectilinear light strips, or two curvilinear light bands of greater or lesser length, or two substantially annular closed light structures, for example in a non-limiting manner.

Here, the light sources can be secured to the external faces of the metal parts of the side doors or to the internal or external faces of the side door windows, which is important so they can be visible. However, as mentioned above, alternatively or in addition, the light sources could be installed on the side portions of optical units, in front and/or on the back, or on side portions of the roof (or body ceiling), or on external sides of the vehicle body bottom structure, or on the outer faces of the front and/or rear fenders, or on the side portions of the front and/or rear bumpers, for example.

The control means MC is able to generate the first command for the signaling means MSj when the vehicle VA is in an autonomous driving phase.

Thus, when a third party observes the first light, generated automatically and independently of any analysis of the environment, on at least one of the side portions PLk of the vehicle VA, it instantly understands that the latter (VA) is an autonomous vehicle in a phase of autonomous driving (controlled by its assistance device DA), which is likely to give immediate reassurance.

It should be noted that in the exemplary embodiment illustrated in a non-limiting manner in the single figure, the control means MC is part of a computer C1, possibly performing at least one other function within the vehicle VA, and preferably connected to the communication network of the vehicle VA (possibly of the multiplexed type and allowing the exchange of information between on-board electronic equipment). However, this is not mandatory. Indeed, the signaling device DS could include its own computer including its control means MC and connected to the possible communication network of the vehicle VA. Therefore, the control means MC may be in the form of software modules or a combination of electronic circuits or components (or “hardware”) and software modules.

It will also be noted that the control means MC can be informed by the assistance device DA of the driving phase in which its vehicle VA is located at the moment in question, either via a direct connection between the computer C1 and the assistance device DA, or indirectly via another computer and/or the possible communication network of the vehicle VA.

In order to allow third parties to differentiate autonomous driving phases with and without driver, several embodiments can be envisioned.

In a first embodiment, the control means MC may be able to generate the first command when the driver is absent from the vehicle VA, and to generate a second command for the signaling means MSj when the vehicle VA is in an autonomous driving phase and the driver is present in the vehicle VA. Moreover, in this first embodiment, the signaling means MSj is capable of generating a second light of a second selected color, visible from outside the vehicle VA, in case of receipt of the second command.

Thus, when a third party observes the first light on at least one of the side portions PLk of the vehicle VA, the third party instantly understands that the latter is an autonomous vehicle (VA) in an autonomous driving phase without a driver (controlled by its assistance device DA). And, when a third party observes the second light on at least one of the side portions PLk of the vehicle VA, the third party instantly understands that the latter is an autonomous vehicle (VA) in an autonomous driving phase with a driver (but controlled by the single assistance device DA).

As a purely illustrative example, the first color of the first light may be white and the second color of the second light may be blue. This is only an example, and therefore other colors may be selected, possibly according to regulations in force.

It will be noted that in this first embodiment the signaling means MSj can also be adapted to generate the second light intermittently in case of receipt of a third command. In this case, the control means MC is able to generate the third command for the signaling means MSj when the vehicle VA is in a transition phase between an autonomous driving phase and a manual driving phase.

If we move from an autonomous driving phase with driver to a manual driving phase, the third party will observe the second light continuously (autonomous driving phase), then intermittently (transition phase), then the disappearance of this second light (manual driving phase following the complete resumption of control of the vehicle VA by its driver). On the other hand, if we move from a manual driving phase to an autonomous driving phase with a driver, the third party will observe an absence of light (manual driving phase), then the second light intermittently (transition phase), and finally the second continuous light (autonomous driving phase following the complete resumption of control of the vehicle VA by the assistance device DA).

In a second embodiment, the control means MC may be able to generate the first command when the driver is present in the vehicle VA, and to generate a second command for the signaling means MSj when the vehicle VA is in an autonomous driving phase and the driver is absent from the vehicle VA. Moreover, in this first embodiment, the signaling means MSj is capable of generating a second light of a second selected color, visible from outside the vehicle VA, in case of receipt of the second command.

Thus, when a third party observes the first light on at least one of the side portions PLk of the vehicle VA, the third party instantly understands that the latter (VA) is an autonomous vehicle in an autonomous driving phase with a driver (but controlled by the single assistance device DA). And, when a third party observes the second light on at least one of the side portions PLk of the vehicle VA, the third party instantly understands that the latter (VA) is an autonomous vehicle in an autonomous driving phase without a driver (controlled by its assistance device DA).

As a purely illustrative example, the first color of the first light may be blue and the second color of the second light may be white. This is only an example, and therefore other colors may be selected, possibly according to regulations in force.

It will be noted that in this second embodiment the signaling means MSj can also be adapted to generate the first light intermittently in case of receipt of a third command. In this case, the control means MC is able to generate the third command for the signaling means MSj when the vehicle VA is in a transition phase between an autonomous driving phase and a manual driving phase.

If we move from an autonomous driving phase with driver to a manual driving phase, the third party will observe the first light continuously (autonomous driving phase), then intermittently (transition phase), then the disappearance of this first light (manual driving phase following the complete resumption of control of the vehicle VA by its driver). On the other hand, if we move from a manual driving phase to an autonomous driving phase with a driver, the third party will observe an absence of light (manual driving phase), then the first light intermittently (transition phase), and, finally, the first light continuously (autonomous driving phase following the complete resumption of control of the vehicle VA by the assistance device DA).

It will be noted that instead of using a first or second light intermittently during a transition phase, a third light of a third selected color may be used during this phase. In this variant or option, the signaling means MSj may be able to generate a third light of a third selected color, visible from outside the vehicle VA, in case of receipt of a third command. In this case, the control means MC is able to generate the third command for the signaling means MSj when the vehicle VA is in a transition phase between an autonomous driving phase and a manual driving phase.

Thus, if we move from an autonomous driving phase with a driver to a manual driving phase, the third party will observe the first (or possibly th second) light continuously (autonomous driving phase), then the third light continuously or possibly intermittently (transition phase), then the absence of light (manual driving phase following the complete resumption of control of the vehicle VA by its driver). Similarly, if we move from a manual driving phase to an autonomous driving phase with a driver, the third party will observe an absence of light (manual driving phase), then the third light continuously or possibly intermittently (transition phase), and finally the first (or possibly th second) light continuously (autonomous driving phase following the complete resumption of the control of the vehicle VA by the assistance device DA).

As a purely illustrative example, the third color of the third light may be orange or red. This is only an example, and therefore another color can be selected, possibly according to regulations in force.

It will be noted that during a transition phase, instead of using a first or second light intermittently or a third light of a third selected color, the signaling means MSj may be able, upon receipt of the first (or possibly second or third) command, to increase the intensity of the first (or possibly second) light between a zero value and a maximum value (during the transition from the manual driving phase to the autonomous driving phase) or conversely between a maximum value and a zero value (during the transition from the autonomous driving phase to the manual driving phase).

It will also be noted that the different colors mentioned above may result from light source(s) respectively delivering light of different wavelengths, or from light source(s) each delivering light of all wavelengths corresponding to these different colors.

It will also be noted, as illustrated not only in the single figure, that the signaling means MS2 (j=2) may comprise, in addition, light sources secured to a front portion and/or a rear portion of the vehicle VA where permitted by the regulations in force. For example, these complementary light sources may be installed on front parts of front optical units and/or on rear parts of rear optical units, or on a front part and/or a rear part of the roof (or body ceiling), or on an inner or outer side of the windshield, or on the front hood and/or on the trunk door (or tailgate) on the rear, or on a front and/or a rear portion of the vehicle body bottom structure, or on a inner or outer face of the rear window, or on a front part of the front bumper and/or a rear part of the rear bumper, or on a brand logo.

In the latter option, the complementary light sources may be rectilinear or curvilinear light strips of greater or lesser length, or substantially closed annular light structures, or even light signs or symbols, for example and in a non-limiting manner.

Thanks to the automatic and independent light signaling of any analysis of the environment which is offered by the invention, a third party who observes an autonomous vehicle can now instantly determine the driving phase in which it is operated, which is likely to reassure this third party immediately.

1. A signaling device for a vehicle comprising an assistance device; the vehicle being capable of being driven by a driver during a manual driving phase and being capable of being driven completely autonomously during an autonomous driving phase, the signaling device comprising a control means, signaling means adapted to be installed on at least two side portions of said vehicle and to generate a first light of a first selected color, visible from the outside of said vehicle, in case of receipt of a first command from said control means,
said control means generating said first command for said signaling means when said vehicle is in an autonomous driving phase and when said driver is absent from said vehicle, and generating a second command for said signaling means when said vehicle is in an autonomous driving phase and said driver is present in said vehicle, or
said control means generating said first command when said driver is present in said vehicle, and generating a second command for said signaling means when said vehicle is in an autonomous driving phase and said driver is absent from said vehicle,
wherein said signaling means is suitable for generating a second light of a second selected color, visible from outside said vehicle (VA), in case of receipt of said second command.

2. The signaling device according to claim 1, wherein said signaling means is adapted to generate said second light intermittently upon receipt of a third command, and in that said control means is adapted to generate said third command for said signaling means when said vehicle is in a transition phase between an autonomous driving phase and a manual driving phase.

3. The signaling device according to claim 1, wherein said signaling means is adapted to generate a third light of a third selected color, visible from outside said vehicle, in case of receipt of a third command, and in that said control means is adapted to generate said third command for said signaling means when said vehicle is in a transition phase between an autonomous driving phase and a manual driving phase.

4. A vehicle capable of being driven by a driver during a manual driving phase and comprising an assistance device capable of driving said vehicle completely autonomously during an autonomous driving phase, wherein said vehicle comprises the signaling device according to claim 1, said signaling device being at least partially installed on at least two side portions of said vehicle.

5. The vehicle according to claim 4, wherein at least part of the signaling means of said signaling device is installed on elements of said vehicle selected from side doors, optical units, a roof, side windows, a bottom of a body, front fenders, rear fenders, parts defining the logos of a brand of the said vehicle (VA), a rear window, a windshield, a front bumper, a rear bumper, a rear tailgate, a rear trunk door, and a front hood.

6. The vehicle according to claim 4, wherein said vehicle is of the automotive type.
